(19) United States
(12) Patent Application Publication
(10) Pub. No.: US 2025/0252868 A1
(43) Pub. Date: Aug. 7, 2025

(54) MODULAR, 3D PRINTABLE KIT FOR SMALL SCALE LASER OPTICS EXPERIMENTS

(71) Applicant: ERIK ALEXANDER MUNIZ, IRVINE, CA (US)

(72) Inventor: ERIK ALEXANDER MUNIZ, IRVINE, CA (US)

(21) Appl. No.: 18/631,263

(22) Filed: Apr. 10, 2024

Related U.S. Application Data
(60) Provisional application No. 63/550,261, filed on Feb. 6, 2024.

(51) Int. Cl. G09B 23/22

(52) U.S. Cl. CPC G09B 23/22

(57) ABSTRACT

A laser optics experiment kit comprises a puzzle-style baseplate; an adapter plate configured to releasably attach to the baseplate; a plurality of components configured to attach to the adapter plate and baseplate, including: a laser holder; a mirror mount assembly; a beamsplitter mount assembly; an iris mount assembly; a lens mount assembly; and a rotation plate assembly a baseplate; an adapter plate configured to directly attach to the baseplate; a plurality of adapter components configured to releasably attach in varying angular positions to the adapter plate, including: a mirror mount assembly; a beamsplitter assembly; an iris mount assembly; a lens mount assembly; and a viewing panel.

### BACKGROUND OF THE DISCLOSURE

The present disclosure generally relates to laser optics experimental kits and, more particularly, to apparatus for 3D printable kits for laser optics experiments.

Teaching kits to learn about laser optics exist. The kits have been designed to teach students about the properties of coherent laser light (i.e. polarization, intensity, and phase) and its interaction with matter (i.e. is the light reflected, absorbed, and/or transmitted).

3D printed kits for optic experiments exist. Most either do not use a coherent light source such as a laser and cannot perform experiments such as those involving interferometry. There are some where the design constrains the laser beam path to either a normal or 45-degree angle of incidence. This does not reflect a typical experiment in an optics lab.

As can be seen, there is a need for improved apparatus for 3D printable kits for laser optics experiments that more closely reflect techniques and methods in an experimental optics lab, especially for teaching purposes.

### SUMMARY OF THE DISCLOSURE

In one aspect of the present disclosure, a laser optics experiment kit comprises a baseplate; an adapter plate configured to directly attach to the baseplate; a plurality of adapter components configured to releasably attach in varying angular positions to the adapter plate, including: a mirror mount assembly; a beamsplitter assembly; an iris mount assembly; a lens mount assembly; and a viewing panel.

In another aspect of the present disclosure, a laser optics experiment kit comprises a baseplate; an adapter plate configured to attach to the baseplate; a plurality of baseplate components configured to directly attach to the baseplate, including: a laser holder; and a rotation plate assembly.

In a further aspect of the present disclosure, a laser optics experiment kit comprises a modular baseplate; an adapter plate configured to releasably attach to the baseplate; at least one of a plurality of components configured to releasably attach in varying angular positions to the adapter plate, including: a lens holder; a mirror mount assembly; a beamsplitter assembly; an iris mount assembly; a lens mount assembly; a viewing panel; and a rotation plate assembly.

These and other features, aspects and advantages of the present disclosure will become better understood with reference to the following drawings, description, and claims.

### BRIEF DESCRIPTION OF THE DRAWINGS

FIG. 1 is a perspective view of a baseplate according to an exemplary embodiment of the present disclosure.

FIGS. 2A-2B are views of an adapter plate according to an exemplary embodiment of the present disclosure.

FIG. 3 is a perspective view of a laser holder according to an exemplary embodiment of the present disclosure.

FIGS. 4A-4B are views of a part of a mirror mount assembly according to an exemplary embodiment of the present disclosure.

FIGS. 5A-5B are views of another part of the mirror mount assembly according to an exemplary embodiment of the present disclosure.

FIGS. 6A-6C are exploded, perspective views of the mirror mount assembly according to an exemplary embodiment of the present disclosure.

FIG. 7 is a perspective view of an adjustment knob according to an exemplary embodiment of the present disclosure.

FIGS. 8A-8B are views of a part of a beamsplitter assembly according to an exemplary embodiment of the present disclosure.

FIGS. 9A-9B are views of another part of the beamsplitter assembly according to an exemplary embodiment of the present disclosure.

FIG. 10 is an exploded, perspective view of the beamsplitter assembly according to an exemplary embodiment of the present disclosure.

FIGS. 11A-11B are views of a post holder according to an exemplary embodiment of the present disclosure.

FIGS. 12A-12B are views of a part of an iris mount assembly according to an exemplary embodiment of the present disclosure.

FIG. 13 is an exploded, perspective view of the iris mount assembly according to an exemplary embodiment of the present disclosure.

FIGS. 14A-14B are views of a part of a lens mount assembly according to an exemplary embodiment of the present disclosure.

FIGS. 15A-15B are exploded, perspective views of the lens mount assembly according to an exemplary embodiment of the present disclosure.

FIG. 16 is a perspective view of a viewing panel according to an embodiment of the present disclosure.

FIGS. 17A-17B are views of a part of a rotation plate assembly according to an exemplary embodiment of the present disclosure.

FIGS. 18A-18B are views of another part of the rotation plate assembly according to an exemplary embodiment of the present disclosure.

FIGS. 19A-19B are views of an additional part of the rotation plate assembly according to an exemplary embodiment of the present disclosure.

FIGS. 20A-20B are exploded, perspective views of the rotation plate assembly according to an exemplary embodiment of the present disclosure.

FIGS. 21A-21B are views of a first system according to an exemplary embodiment of the present disclosure.

FIGS. 22A-22C are views of a second system according to an exemplary embodiment of the present disclosure.

FIGS. 23A-23B are views of a third system according to an exemplary embodiment of the present disclosure.

FIGS. 24A-24B are views of a fourth system according to an exemplary embodiment of the present disclosure.

FIGS. 25A-25B are views of a fifth system according to an exemplary embodiment of the present disclosure.

FIG. 26 is a perspective view of a kit according to an exemplary embodiment of the present disclosure.

### DETAILED DESCRIPTION OF THE DISCLOSURE

The following detailed description is of the best currently contemplated modes of carrying out the disclosure. The description is not to be taken in a limiting sense, but it is merely for the purpose of illustrating the general principles of the disclosure, since the scope of the disclosure is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

As used herein, the terms “embodiment” and “embodiments” are intended to be used interchangeably. In other words, the singular includes the plural, and vice versa.

The technical problems to be solved herein are that equipment for laser optics experiments is expensive. An individual (student or otherwise) seeking to learn more about the field of laser optics cannot reasonably acquire the equipment necessary to perform experiments without incurring significant financial cost. The existing equipment can have limited capability in performing different types of experiments. At the same time, the equipment cannot be overly complex so that it can be used for teaching purposes.

Broadly, the present disclosure solves the foregoing problems by providing modular 3D printable components that can be “mixed and matched” to conduct laser optics experiments.

The following are exemplary experiments that may be conducted with components of the present disclosure.

Michelson interferometer—A Michelson interferometer consists of a beam splitter and two mirrors. Laser light is split through the beamsplitter and reflected off two mirrors. The recombined light produces an interference fringe pattern at the output. The interference pattern can then be used to precisely determine the difference in path length between the two paths.

Mach Zehnder Interferometer—A Mach Zehnder interferometer is a device used to determine the relative phase shift between two optical paths. The configuration is as follows: coherent laser light is split on a beamsplitter such that light is partially transmitted and reflected. The laser light traverses separate optical paths both being reflected by mirrors at a 45-degree angle and ultimately recombined at a beamsplitter. Two viewing panels are configured at both the transmitted and reflected port of the second beamsplitter. It can be observed that the light interferes constructively at one port while interfering destructively at the adjacent port. A Mach Zehnder interferometer is similar to a Michelson interferometer in the sense that the interference of light is measured; however, light passes through each optical path only once before it is measured at the output (viewing panel).

Malus's law experiment—Demonstrates how the intensity of light varies as a function of the polarization angle of light. Malus's law states that the intensity of plane polarized light transmitted by an analyzer (second polarizer) varies as a function of cosine squared of the angle between the transmission axis of an initial polarizer and the analyzer. For unpolarized light, the polarization axis is determined by an initial polarizer in the path. For light that is already polarized (e.g., coherent laser light) an initial polarizer only allows laser light whose polarization direction is aligned with the polarizer to pass. Passing either source of light (coherent or incoherent) through a second polarizer (analyzer) allows only the component of light that is parallel to the transmitted axis to pass. Therefore, one can observe that the intensity of the output varies as the transmission axis of the analyzer is rotated.

Brewster's Angle—When laser light is incident on a boundary between two transparent media, some of the optical power will be reflected. Light that is plane polarized will be reflected much less than light that is of perpendicular polarization. An experiment can be configured to quantitatively observe the effect of Brewster's angle. In this experiment, a laser source is incident on a half wave plate which is used to configure the polarization state of the incident light. The light is then incident on a window at some oblique angle greater than 45 degrees. At this point it can be observed that the wave plate can be rotated to a specific angle such that the laser light reflected from the window is minimized for plane polarized light. This experiment demonstrates that for a specific polarization of light (plane polarized), the reflection off the boundary does not occur.

Understanding optical alignment—A mirror is used to align through two apertures. One aperture is placed in the near field and one is placed in the far field. Alignment is first performed by aligning the beam through the near field aperture. Height adjustment is achieved by adjusting the tension of the mounting screws used to attach the mirror assembly to the adapter plate. The mirror mount is then rotated about the vertical axis of the adapter plate to adjust horizontal degrees of freedom. After the beam is sufficiently aligned through the first aperture, the kinematic adjustments on the mirror mount are used to adjust vertical and horizontal degrees of freedom to pass the beam through the far field aperture onto a viewing panel. This ensures the laser beam is aligned along the optical path and is coplanar with the table.

Other exemplary experiments can include single and double slit diffraction and thin-film interference.

The following are exemplary kit components of a laser optics experimental kit of the present disclosure. In embodiments, one or more of the kit components may be 3D printed. The kit components may include baseplate components that include a laser holder 30 and a rotation plate assembly 100, in an embodiment. The baseplate components may be configured to directly attach to a baseplate 10.

In an embodiment, each of the baseplate components can be configured to be positioned at a plurality of baseplate locations 10h on the baseplate 10, as further described below. From another perspective, the baseplate 10 can be configured to receive the baseplate components at a plurality of baseplate locations 10h. Further, each of the baseplate components can be configured to be releasably connected, in varying angular positions, to the baseplate 10. The adapter plate 20 (with a respective adapter component described below) can be configured to be positioned at a plurality of baseplate locations 10h on the baseplate, as further described below. Moreover, the baseplate 10 can be configured to receive the adapter plate 20 at a plurality of baseplate locations 10h.

The kit components may further include adapter plate components that include a mirror mount assembly 40, a beamsplitter assembly 50, an iris mount assembly 70, a lens mount assembly 80 and a viewing panel 90, in an embodiment. The adapter plate components may be configured to releasably attach in varying angular positions to an adapter plate 20 which can, in turn, be releasably attached in varying angular positions to the baseplate 10.

As can be appreciated, the modular nature of the baseplate 10, and the ability to change positions of each of the baseplate and adapter plate components on the baseplate, provides the present disclosure with the ability to conduct a multitude of optic experiments.

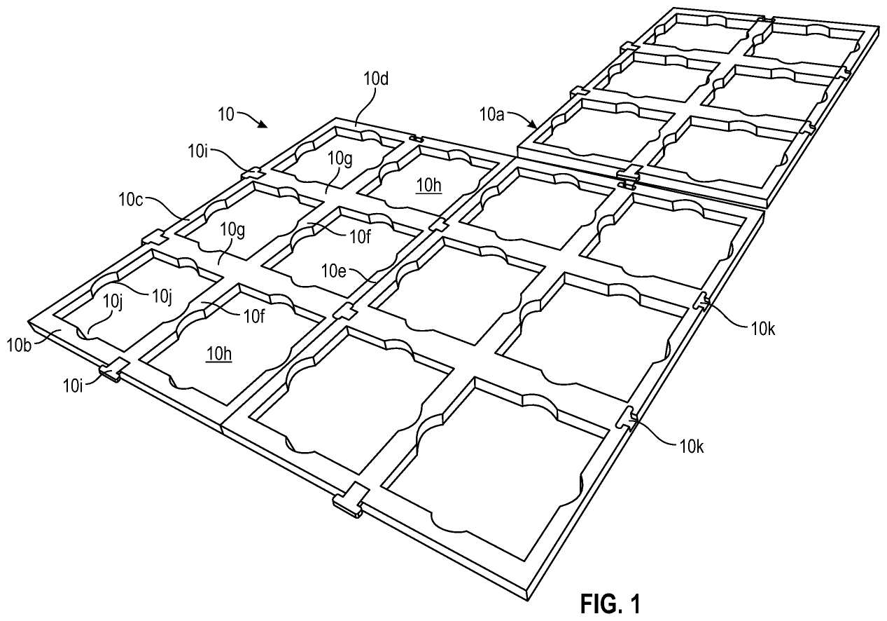

FIG. 1 shows the baseplate 10 according to an exemplary embodiment of the present disclosure. The baseplate 10 is a structure on which kit components 700c (described later) can be placed. In an embodiment, the baseplate 10 may be modular and include one or more baseplate modules 10a. In an embodiment, one or more baseplate modules 10a may be rectangular in shape. In an embodiment, one or more of the baseplate modules 10a may be releasably connected to one another in one or more different ways to create one or more different configurations of the baseplate 10. Moreover, the overall size of the baseplate 10 may be changed, and the perimeter configuration of the baseplate 10 may be changed.

In an embodiment, one or more of the baseplate modules 10a, and therefore the baseplate 10, may include a plurality of baseplate perimeter edges 10b-e and a plurality of baseplate cross bars 10f-g. The perimeter edges 10b-e and the cross bars 10f-g may be the boundaries of one or more baseplate insertion areas or baseplate locations 10h, in an embodiment. As described above, each of the baseplate components and the adapter plate 20 may be directly inserted into the insertion areas 10h.

On one or more of the perimeter edges 10b-e, at an outside surface thereof, may be one or more baseplate first connectors, or baseplate releasable connectors, or baseplate male connectors 10i, according to an embodiment. On one or more of the perimeter edges 10b-e, at an outside surface thereof, may be one or more baseplate second connectors, or baseplate releasable connectors, or baseplate female connectors 10k, according to an embodiment. The baseplate male connectors 10i and the female connectors 10k may be configured to mate with one another, in an embodiment.

On one or more of the perimeter edges, at an inside surface thereof, may be one or more baseplate recesses 10j, according to an embodiment. On one or more of the cross bars 10f-g, may be one or more baseplate recesses 10j, according to an embodiment.

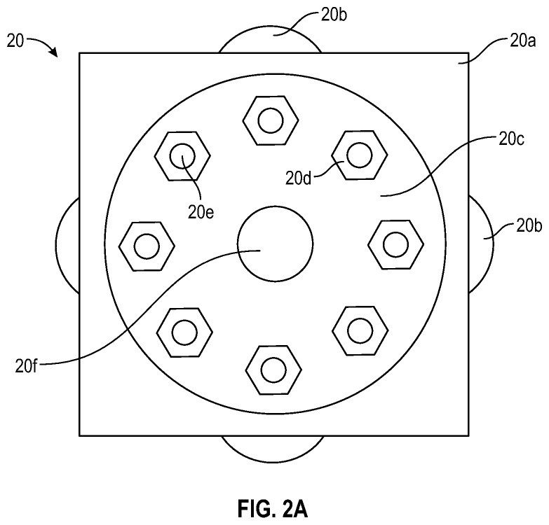

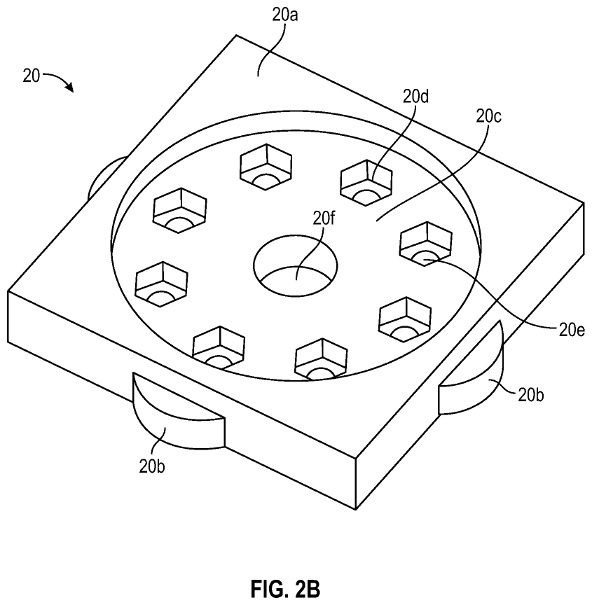

FIGS. 2A-2B show the adapter-plate 20 according to an exemplary embodiment of the present disclosure. The adapter plate 20 can be configured to releasably attach at varying angular positions to each of the adapter components. Each adapter component 700c can be mounted on the adapter plate 20 and the adapter plate 20 can directly attach to the baseplate 10. In an embodiment, the adapter plate 20 can fit within, or be releasably inserted into, the baseplate insertion areas 10h. The adapter plate 20 can be press fitted with m2 nuts (for example) which are used to secure the kit components thereon.

In an embodiment, the adapter plate 20 may include an adapter base 20a that can be configured to press-fit into one or more of the baseplate insertion areas 10. At one or more sides of the adapter base 20a, there can be one or more adapter protrusions 20b which can be configured to press-fit into one or more of the baseplate recesses 10j, in an embodiment.

The adapter plate 20 may further include, at a receiving side of the adapter base 20a, an adapter recess or receiving area 20c which can be configured to receive a base of an adapter component described below, according to an embodiment. The adapter plate 20 may also include an adapter aperture 20f, in the adapter receiving area 20c, which can be configured to a receive a post of an adapter component described below.

In the adapter receiving area 20c, there may be one or more adapter insertion areas 20d that can be configured to receive a nut described below, according to an embodiment. In an embodiment, a plurality of insertion areas 20d can be positioned around a perimeter of the receiving area 20c. In one or more of the adapter insertion areas 20d, there can be an adapter insertion hole 20e that can be configured to receive a bolt described below, according to an embodiment. The foregoing can thereby enable an adapter component to be releasably attached to the adapter plate 20 at varying angular positions relative to one another. Consequently, an adapter component can be positioned at different angles relative to one or more other kit components, such as in the examples described below.

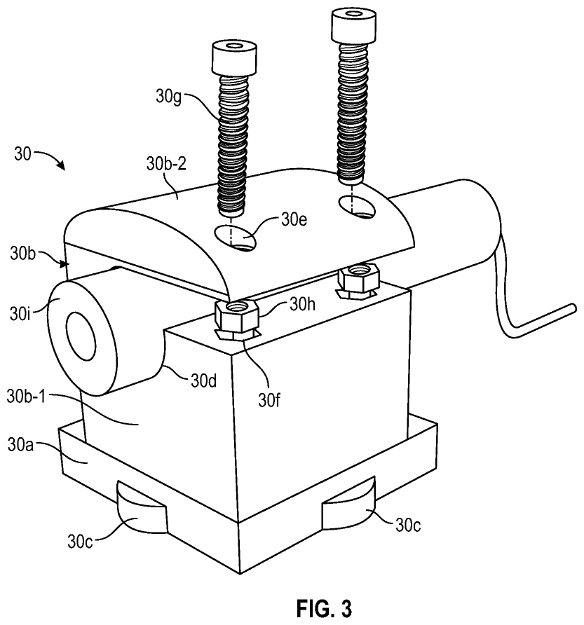

FIG. 3 shows the laser holder 30 according to an exemplary embodiment of the present disclosure. The laser holder 30 can be a mount for securing an 11 mm diameter, for example, laser pointer 30i. In an embodiment, the laser holder 30 can include two (for example) through holes for m2 set screws (for example) and a footprint to mount directly to the baseplate 10, in an embodiment.

The laser holder 30, in an embodiment, may include a holder base 30a configured to directly attach to or press-fit into one or more of the baseplate insertion areas 30h without the use of the adapter plate 20. At the perimeter of the holder base 30a may be one or more holder protrusions 30c that may be configured to press-fit into one or more of the baseplate recesses 10j, in an embodiment. A holder clamp 30b may be supported by the holder base 30a. The holder clamp 30b may include a first clamp engagement part 30b-1 that forms a part (e.g., a bottom part) of a holder engagement area 30d in which a laser 30i may be positioned, in an embodiment. The holder clamp 30b may further include a second clamp engagement part 30b-2 that forms another part (e.g., a top part) of the holder engagement area 30d, in an embodiment.

The laser holder 30, in an embodiment, may further include one or more holder holes 30e, such as in the second clamp engagement part 30b-2. The one or more holder holes 30e may be configured to receive one or more holder bolts 30g. One or more holder insertion holes 30f may be in the first clamp engagement part 30b-1 and aligned with one or more of the holder holes 30e, in an embodiment. The one or more holder insertion holes 30f may be configured to receive one or more holder nuts 30h which can fit onto the holder bolts 30g.

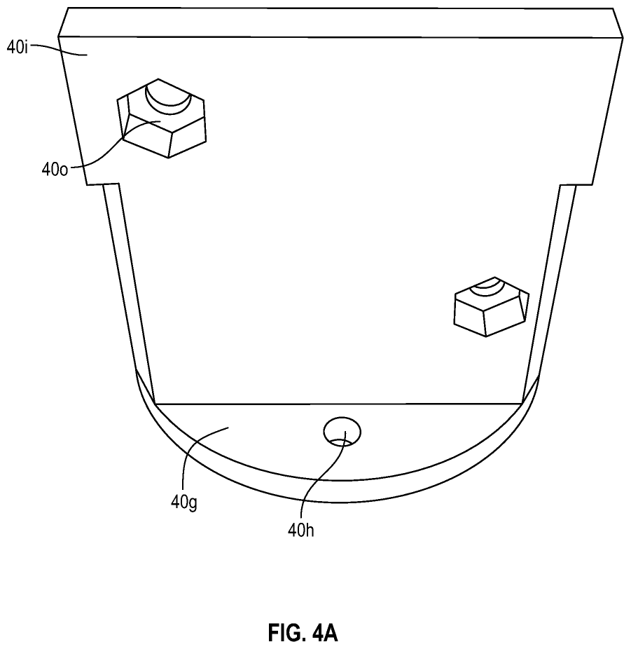

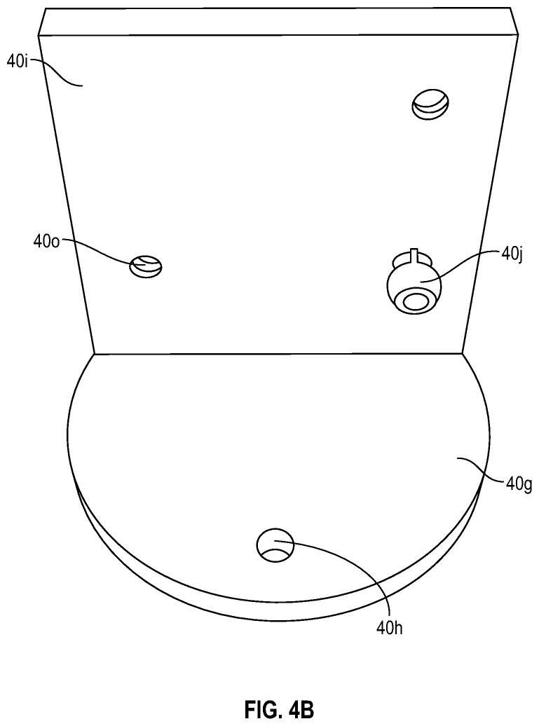

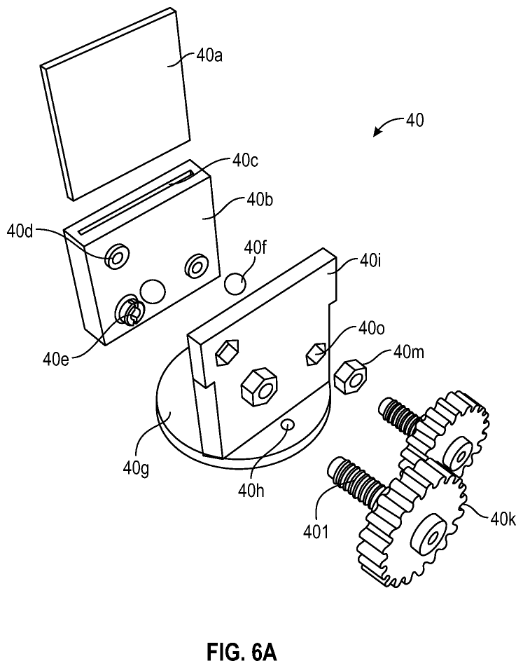

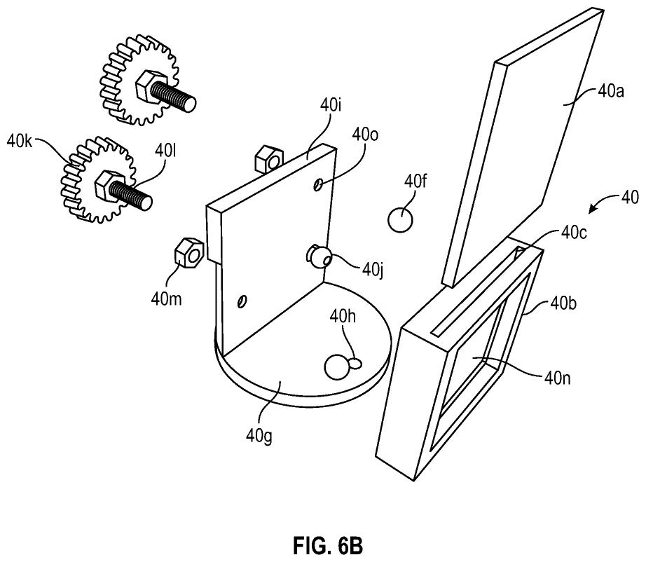

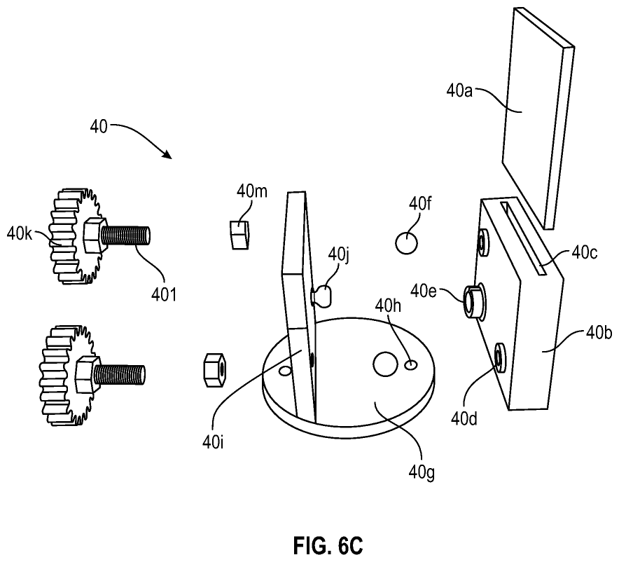

FIGS. 4A-6C show components of and the mirror mount assembly 40 according to an embodiment of the present disclosure. In particular, FIGS. 4A-4B show a mirror-mount back—a back plate supporting front kinematic mirror mount. Features two holes (for example) for m2 nuts (for example) and threaded socket head screw for adjust. An additional ball socket is used as a pivot for front mounting plate. The foot of the mount has mounting features to mount the mirror onto the adapter plate and M2 screw adjust (for example) on the back of the mount.

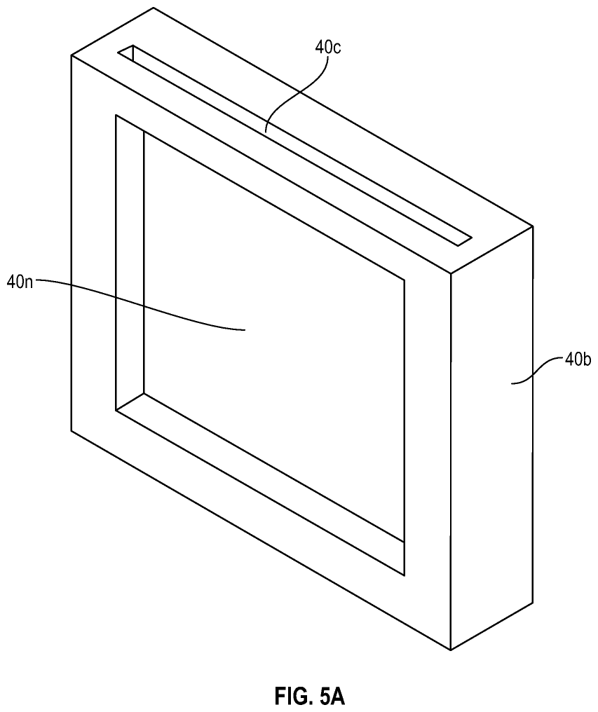

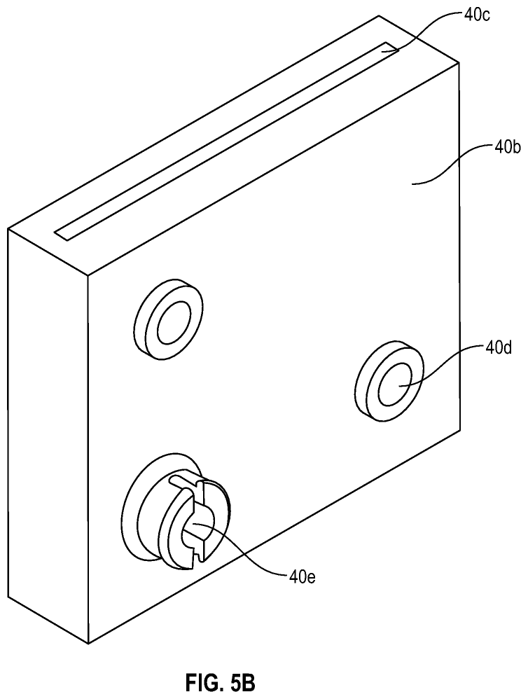

FIGS. 5A-5B show a mirror-mount front—a front plate designed for holding a square optic of dimensions 25×25 mm (for example) with thickness of ˜1.2 mm (for example). Features socket for pivot about horizontal and vertical axes. 3.5 mm diameter (for example) holes are also included for adhering spherical ball magnets of diameter 3 mm (for example).

The mirror mount assembly 40, in an embodiment, may include a mirror 40a configured to reflect light from the laser 30i. Since the mirror mount assembly 40 can be releasably connected to the adapter plate 20 in varying angular positions, the mirror mount assembly 40 can be adjusted to reflect laser light at different angles.

A mirror holder 40b may include a mirror holder slot 40c configured to receive the mirror 40a therein. A mirror holder reflection area 40n can be on a reflection side of the mirror holder 40b and provide an exposed area of the mirror 40a, in an embodiment, In an opposite side (i.e., a non-reflection side) of the mirror holder 40b may be one or more mirror holder supports or depressions 40d, each of which can be configured to receive a respective mirror magnet 40f, in an embodiment. A mirror holder receiving part 40e is also on the non-reflection side of the mirror holder 40b and configured to receive a mirror wall insertion part 40j (such as like a knub) on a mirror wall 40i described below, in an embodiment.

According to an embodiment, the combination of the mirror holder depressions 40d holding the mirror magnets 40f, and the mirror wall insertion part 40j in the mirror holder receiving part 40e, can act to maintain attachment between the mirror holder 40b and a mirror wall 40i described below.

In an embodiment, the mirror mount assembly 40 may include a mirror base 40g that can be configured to fit in the adapter receiving area 20c of the adapter plate 20. The mirror base 40g can be further configured with one or more mirror base holes 40h for bolting to the adapter plate 20 at the adapter insertion holes 20e, in an embodiment. An upstanding mirror wall 40i can be supported by the mirror base 40g and can include one or more mirror wall holes 400. The one or more mirror wall holes 400 can be configured to receive a respective mirror nut 40m which, in turn, can receive a respective mirror bolt 401 of a mirror adjustment knob 40k, according to an embodiment.

The one or more adjustment knobs 40k may be rotated in opposite directions to increase or decrease pressure on the mirror holder 40b and thereby make adjustments to the position of the mirror holder 40b and thus the mirror 40a, according to an embodiment.

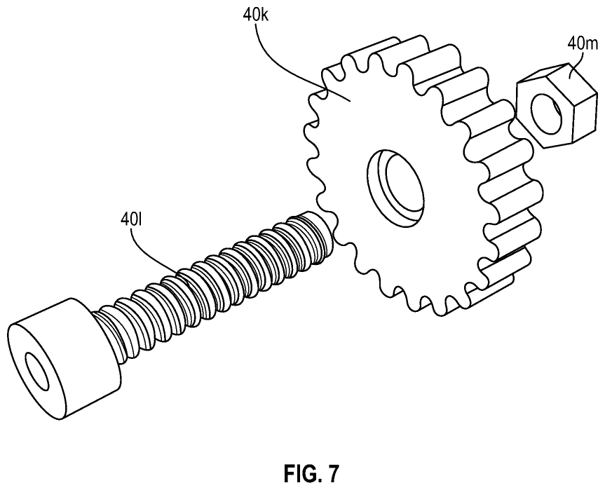

FIG. 7 is an exploded, perspective view of a kinematic adjustment knob assembly according to an exemplary embodiment. The adjustment knob assembly may include the mirror adjustment know 40k, the mirror bolt 401, and the mirror nut 40m.

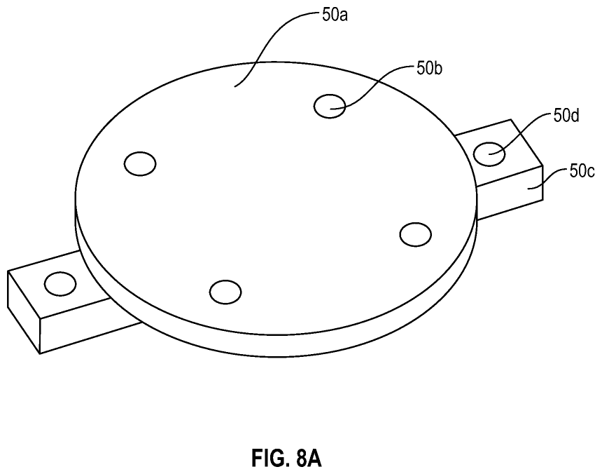

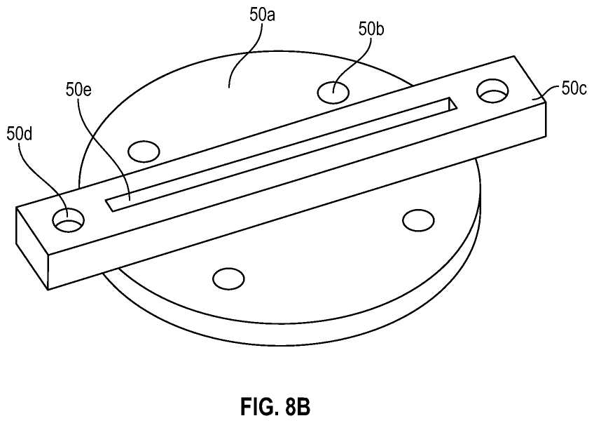

FIGS. 8A-10 show components of and the beamsplitter assembly 50 according to an exemplary embodiment of the present disclosure. The beamsplitter assembly 50 may include a beamsplitter-base that is used for mounting a square optic of 25×25 mm (for example) with ˜1.2 mm thickness (for example). The base has through hole features for catching m2 screws (for example) on an adapter plate. Additional through holes are on side of optic to catch m2 set screw (for example).

The beamsplitter assembly 50 may include a beamsplitter-top-bracket used with m2 screws (for example). It secures a square optic of 25×25 mm (for example) with ˜1.2 mm (for example) thickness to base.

FIGS. 8A-8B show a beamsplitter base 50a that can be configured to fit in the adapter receiving area 20c of the adapter plate 20, according to an embodiment of the present disclosure. One or more beamsplitter base holes 50b can be positioned near a perimeter of the base 50a, in an embodiment. The one or more base holes 50b can be configured to receive a bolt for connection to one or more adapter insertion areas 20d and adapter insertion holes 20e of the adapter plate 20, in an embodiment. A beamsplitter support 50c may be affixed lengthwise across and to the beamsplitter base 50a. A beamsplitter support hole 50d may be located at opposite ends of the beamsplitter support 50c, in an embodiment. A beamsplitter support slot may extend lengthwise in the beamsplitter support 50c.

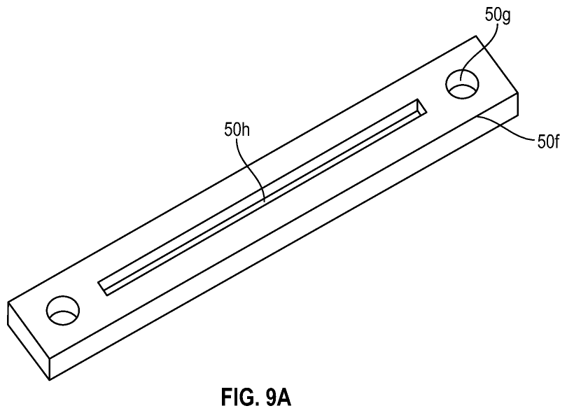

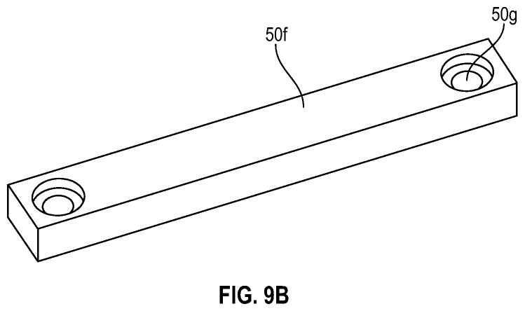

FIGS. 9A-9B show a beamsplitter bracket 50f according to an embodiment of the present disclosure. One or more beamsplitter bracket holes 50g may be at opposite ends of the beamsplitter bracket 50f. A beamsplitter bracket slot 50h may extend lengthwise in the bracket 50f, in an embodiment.

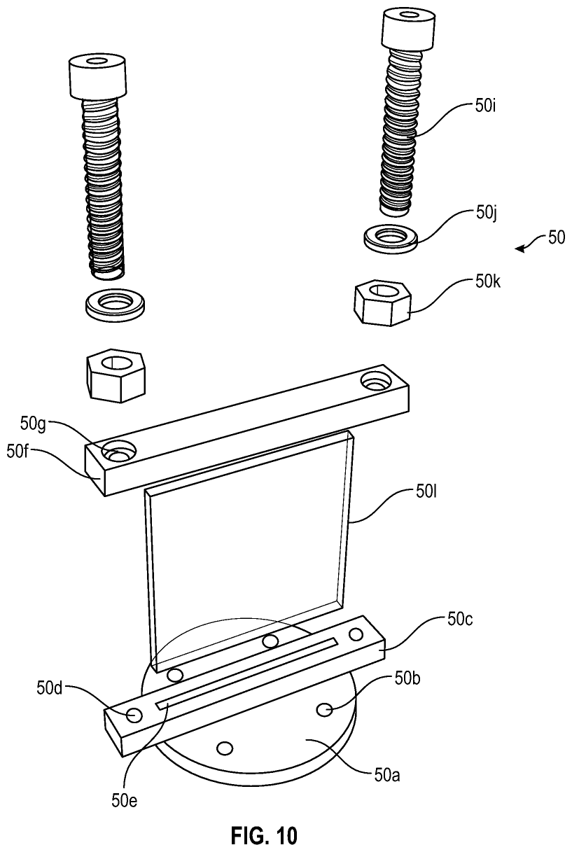

FIG. 10 is an exploded, perspective view of the beamsplitter assembly 50 according to an embodiment of the present disclosure. A beamsplitter or other transparent dielectric 501 is configured to be inserted, at one edge thereof, into the beamsplitter support slot 50e. An opposite edge of the beamsplitter 501 is configured to be inserted into the beamsplitter bracket slot 50h, in an embodiment. A beamsplitter bolt 50i can be inserted into the beamsplitter bracket hole 50g and into the beamsplitter support hole 50d. A beamsplitter washer 50j and beamsplitter nut 50k can be used to secure the bolt 50i to the beamsplitter support 50c and the beamsplitter bracket 50f, in an embodiment.

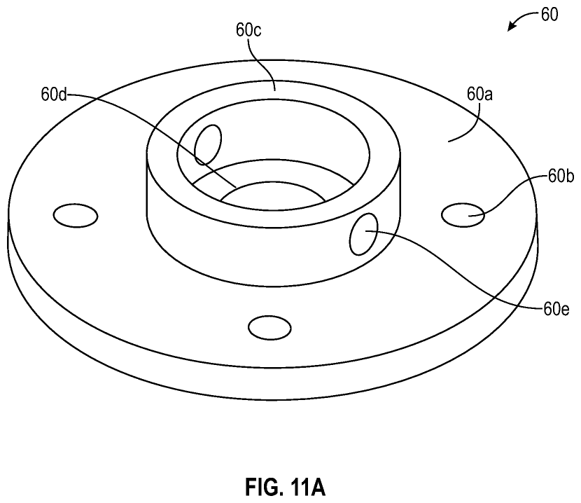

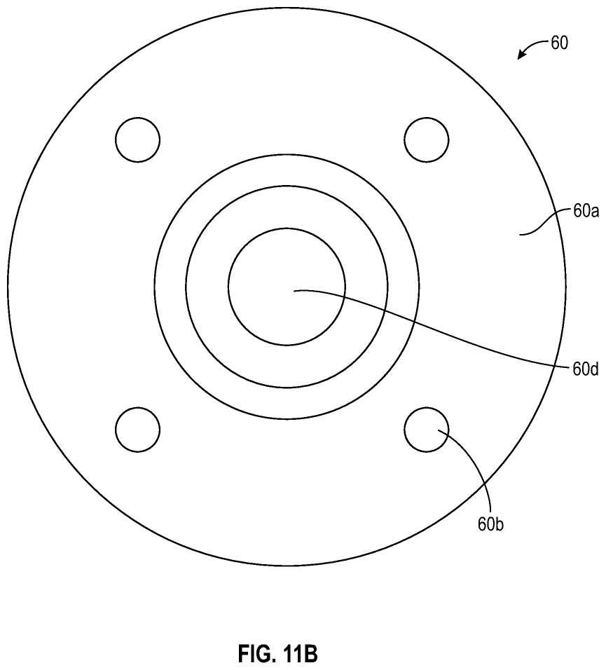

FIGS. 11A-11B show a post holder 60 that can be used for securing post-mounted components to the adapter plate 20. Through-hole in the center allows post to slide through freely. When the desired height is reached, an m2 set screw (for example) is used to lock post in place.

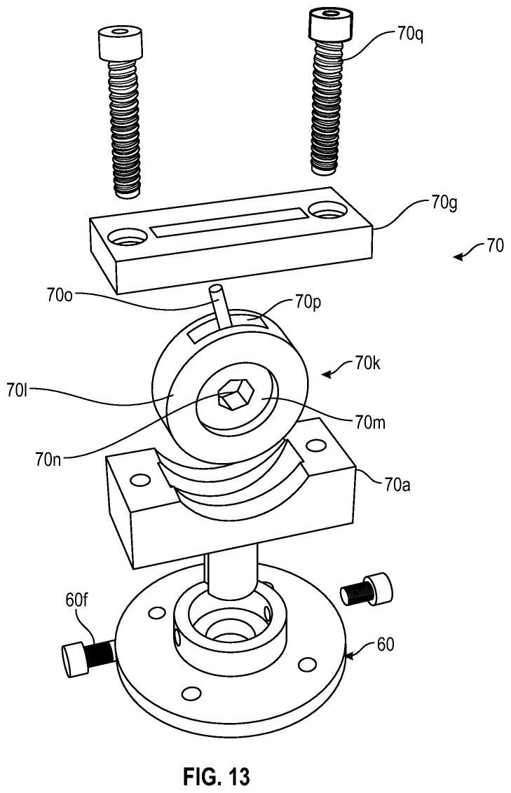

In an embodiment, the post holder 60 may include a post holder base 60a that can be configured to fit in the adapter receiving area 20c of the adapter plate 20. One or more post holder base holes 60b may be positioned near a perimeter of the base 60a, in an embodiment. A post holder support 60c can be an upstanding cylinder that defines a post holder support aperture 60d therein. One or more post holder support holes 60e may be located in the side surface of the support 60c, in an embodiment. As can be appreciated, in an embodiment, the post holder 60 can employ one or more bolts to releasably attach to the adapter plate 20 in varying angular positions, like an adapter component described above. The post holder aperture 60d can be configured to receive a post of an adapter component and fix the same in place with bolt(s) (60f in FIG. 13 for example) in the post holder support holes 60e.

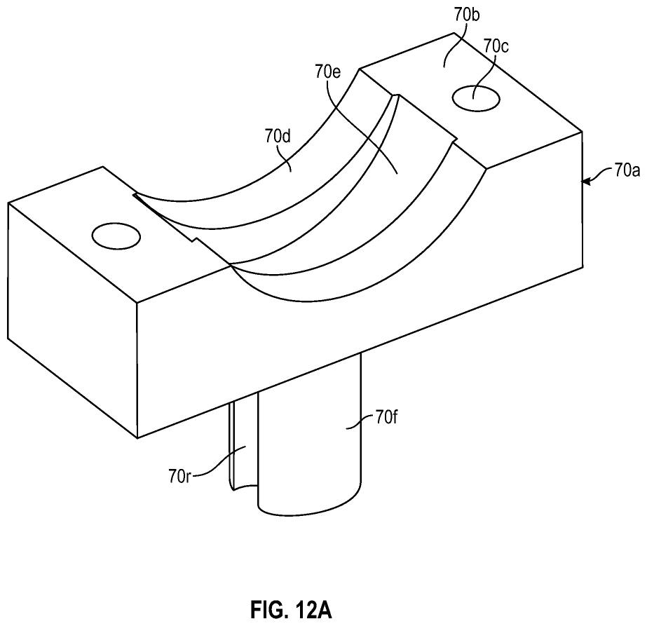

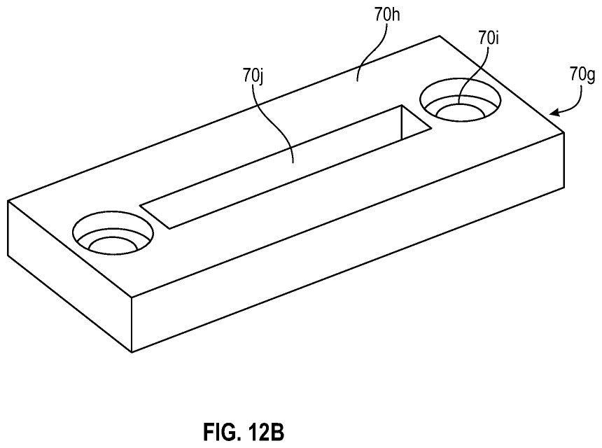

FIGS. 12A-13 show components of and the iris mount assembly 70 according to an embodiment of the present disclosure. An iris mount is a base post with semi-circular mount for securing an 8 mm (for example) diameter aperture component. Features through holes for securing top bracket.

An iris-mount-top is a top bracket for securing 8 mm (for example) aperture. Features through holes for two m2 (for example) socket head screws and rectangular slot for aperture adjustment.

FIG. 12A shows an iris mount first or bottom support 70a of the iris mount assembly 70, according to an embodiment. An iris mount first support planar region 70b may be on opposite ends of the first support 70a, in an embodiment. An iris mount first support hole 70c may be in each of the planar regions 70b. An iris mount first support curved region or depression 70d may be between the planar regions 70b. An iris mount first support curved channel 70e may be in the curved region 70d between the planar regions 70b, in an embodiment. An iris mount first support post 70f may be attached at a side of the first support 70a that is opposite the curved region 70d, in an embodiment. An iris mount first support post slot(s) 70r may be in the post 70f and configured to receive a post holder bolt(s) 60f.

FIG. 12B shows an iris mount second or top support 70g of the iris mount assembly 70, according to an embodiment. An iris mount second support base 70h can include an iris mount second support hole 70i at opposite ends thereof. An iris mount second support slot 70j may extend lengthwise between the support holes 70i, in an embodiment.

FIG. 13 is an exploded, perspective view of the iris mount assembly 70 for insertion into the post holder 60. The iris mount assembly 70 may include an iris mount subassembly 70k that includes an iris mount subassembly housing 701 that can be configured to sit in the iris mount first support curved channel 70e, in an embodiment. Within the housing 701 may be an adjustable iris mount subassembly iris 70m having an iris mount subassembly aperture 70n therein, according to an embodiment. The subassembly iris 70m and the subassembly aperture 70n may be constructed in any fashion known in the art. An iris mount subassembly handle 700 may be connected to the iris 70m. The handle 700 may be actuated by a user within an iris mount subassembly slot 70 to change the size of the iris 70m that can receive a laser light. One or more iris mount bolts 70q may extend through the iris mount second support holes 70i and the iris mount first support holes 70c to secure the position of the iris mount subassembly 70k, in an embodiment.

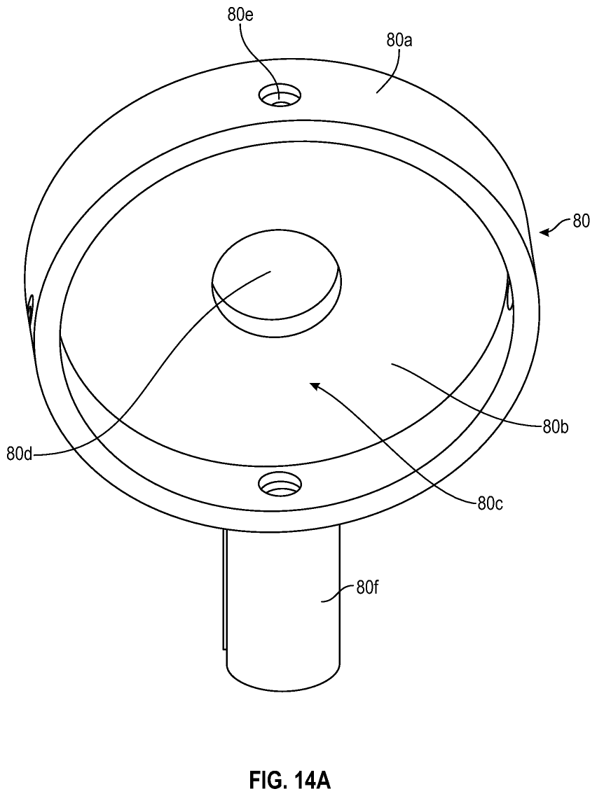

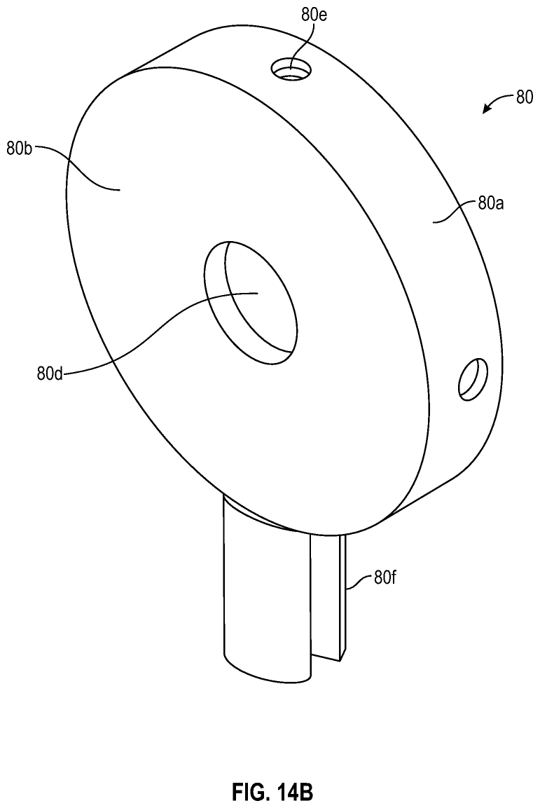

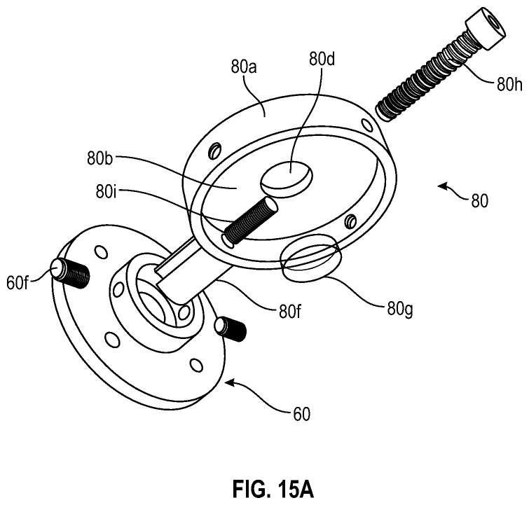

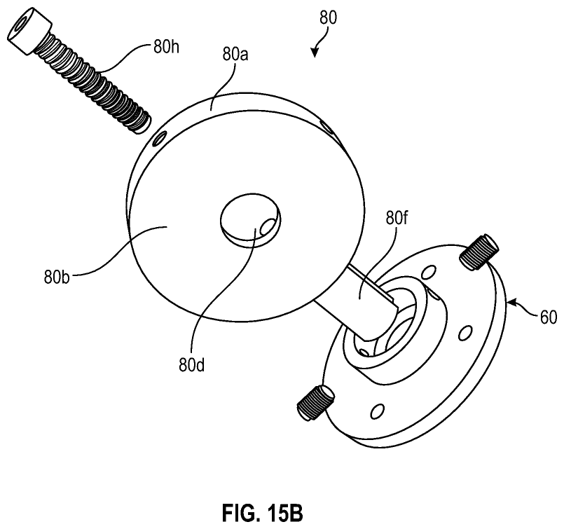

FIGS. 14A-15B show components of and the lens mount assembly 80 according to an embodiment of the present disclosure. A lens-mount is a component for mounting optics with diameters up to 12.5 mm (for example). Optic is held in place using m2 set screws (for example). M2 set screws are used to adjust lens position in the mount. Component is mounted onto “post-holder” and installed on adapter plate.

FIGS. 14A-14B show a lens mount rim 80a of the lens mount assembly 80, in an embodiment. A lens mount base 80b can be encircled by the rim 80a. A lens mount cavity 80c can be formed by the rim 80a and the base 80b, in an embodiment. A lens mount aperture 80d may be in the base 80b. One or more lens mount holes 80e can be in the rim 80a. A lens mount post 80f can be attached to the rim 80a and configured to fit into the post holder 60, in an embodiment.

FIGS. 15A-15B are exploded, perspective views of the lens mount assembly 80 for attachment to the post holder 60, in an embodiment. A lens or optic 80g (such as 8 mm) may be placed in the lens mount cavity 80c and opposite the lens mount aperture 80d. A lens mount bolt 80h can extend through a lens mount hole 80e to contact an edge of the lens 80g, in an embodiment. A lens mount stud 80i can be supported in another lens mount hole 80e and contact the edge of the lens 80g, such as at a point on the edge that is opposite to the point of contact by the bolt 80h, in an embodiment. Thereby, the position of the lens 80g can be adjusted and fixed in a position relative to the aperture 80d.

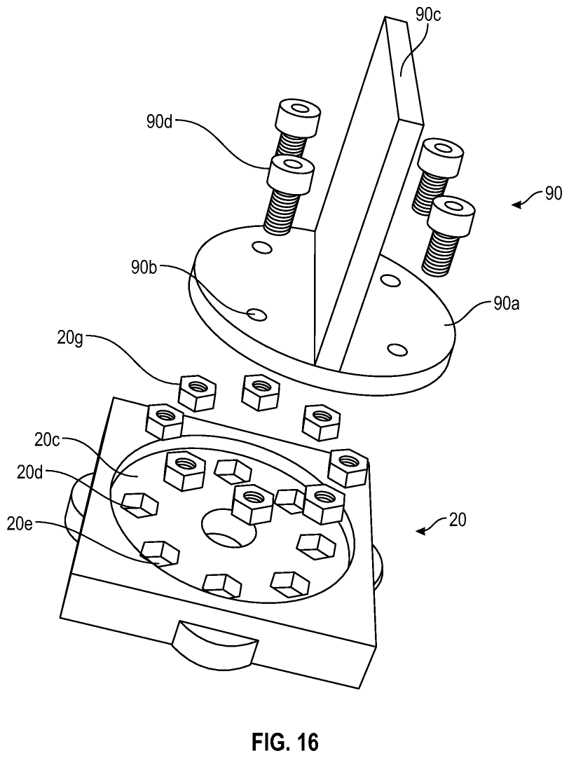

FIG. 16 is an exploded, perspective view of the viewing panel 90 for releasable attachment at varying angular position to an adapter plate 20 in an embodiment of the present disclosure. The viewing-panel is a flat panel used for viewing the beam. The viewing panel 90, in an embodiment, can include a viewing panel base 90a that can be configured to fit into the adapter receiving area 20c of the adapter plate 20. One or more viewing panel base holes 90b may be positioned near a perimeter of the base 90a. A viewing panel wall 90c may extend upwardly from the base 90a and may serve as a surface on which a laser beam may be viewed. One or more viewing panel bolts 90d may extend through the one or more base holes 90b, through one or more adapter nuts 20g, into one or more adapter insertion areas 20d that hold the adapter nuts 20g, and then into the one or more adapter insertion holes 20e in the insertion areas 20d, in an embodiment.

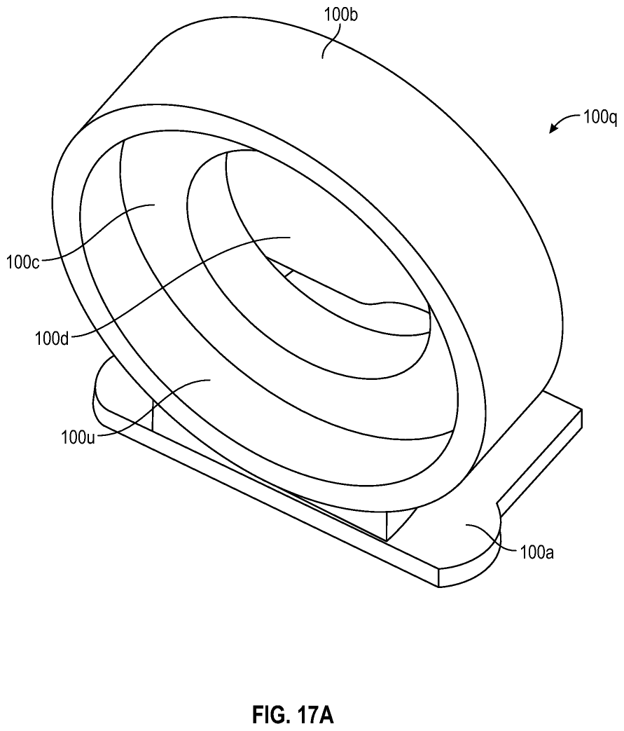

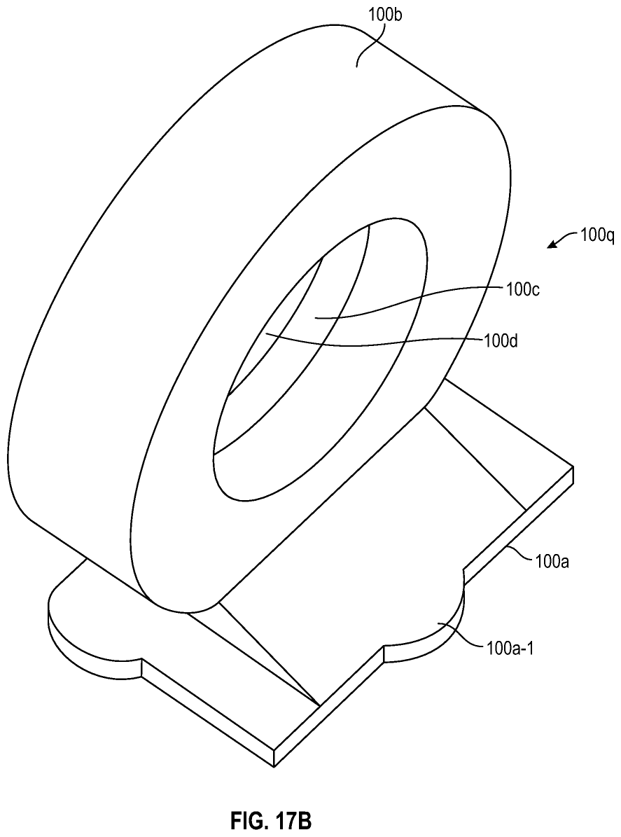

FIGS. 17A-20B show components of and the rotation plate assembly 100 in an embodiment of the present disclosure. A rotation-plate-back is a footprint feature for mounting directly to puzzle baseplate. Supports front rotation plate and supported optic.

A rotation-plate-front is a holder for mounted optic. Rotates freely about the inside of “rotation-plate-back”.

A rotation-plate-key” is an M2 set screw is used with key to mount desired optic onto “rotation-plate-front”.

FIGS. 17A-17B show a plate assembly housing 100q of the rotation plate assembly 100 in an embodiment of the present disclosure. The housing 100q can include a plate assembly base 100a that may be configured to fit into one or more baseplate insertion areas 10h, in an embodiment. The plate assembly base 100a may include one or more plate assembly base protrusions 100a-1 at an edge(s) thereof. The base protrusions 100a-1 may be configured to fit into one or more of the baseplate recesses 10j, in an embodiment.

The plate assembly base 100a can support a plate assembly exterior rim 100b, in an embodiment. A plate assembly interior rim 100c may be within the exterior rim 100b, in an embodiment. The interior rim 100c may define a plate assembly aperture 100d. The combination of the exterior rim 100b and one side of the interior rim 100c can define a plate assembly base receiving area 100u, in an embodiment.

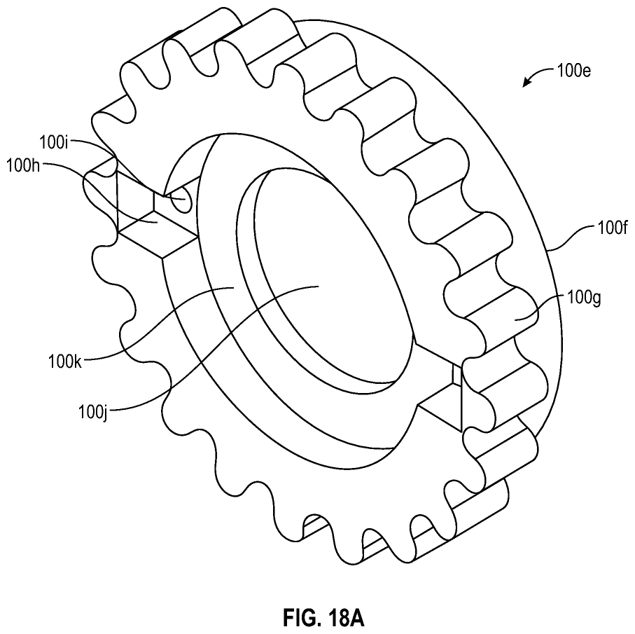

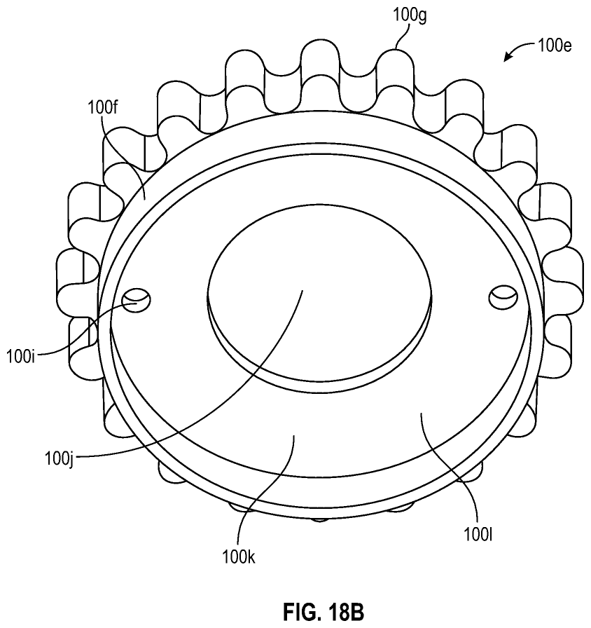

FIGS. 18A-18B show a plate assembly knob 100e according to an embodiment of the present disclosure. The knob 100e may include a plate assembly knob rim 100f that supports one or more plate assembly knob teeth 100g about a circumferential edge thereof, in an embodiment. One or more plate assembly knob slots 100h can be radially inward of the teeth 100g. Adjacent to the slots 100h can be a plate assembly knob hole 100j, in an embodiment. The knob rim 100f and the knob teeth 100g may define a plate assembly knob aperture 100j therethrough. On a side of the rim 100f opposite the teeth 100g, a plate assembly ledge 100k and the rim 100f may define a plate assembly cavity 1001.

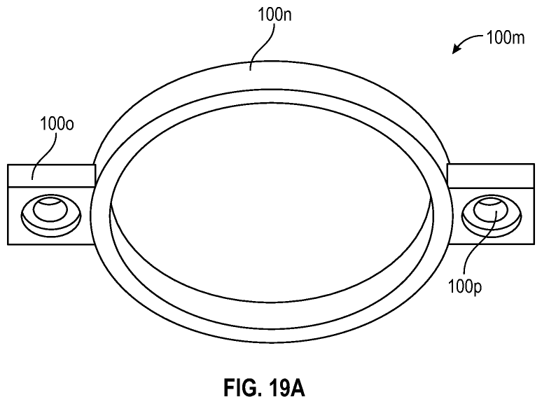

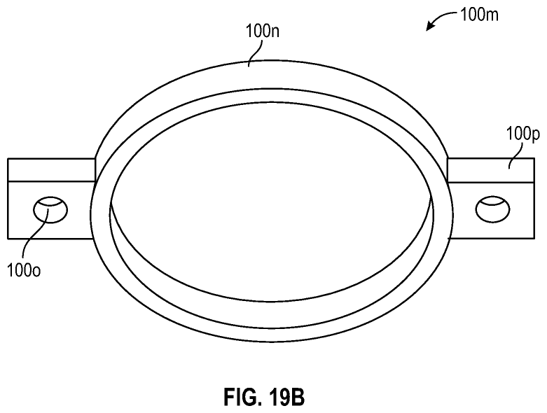

FIGS. 19A-19B show a plate assembly key 100m according to an embodiment of the present disclosure. The key 100m may include a plate assembly ring 100n which can be configured to fit into the plate assembly base receiving area 100u. One or more plate assembly ring extensions 100p may be on an outer surface of the ring 100n, in an embodiment. The ring extensions 100p can be configured to fit into the one or more plate assembly knob slots 100h, in an embodiment. In the ring extensions 100p, one or more plate assembly ring holes 1000 may extend therethrough, in an embodiment. The ring holes 1000 may thus align with the one or more plate assembly knob holes 100i.

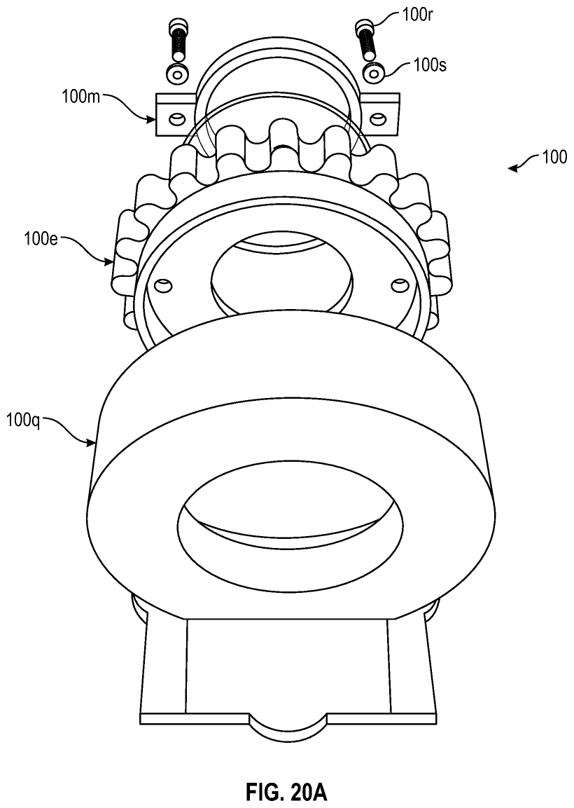

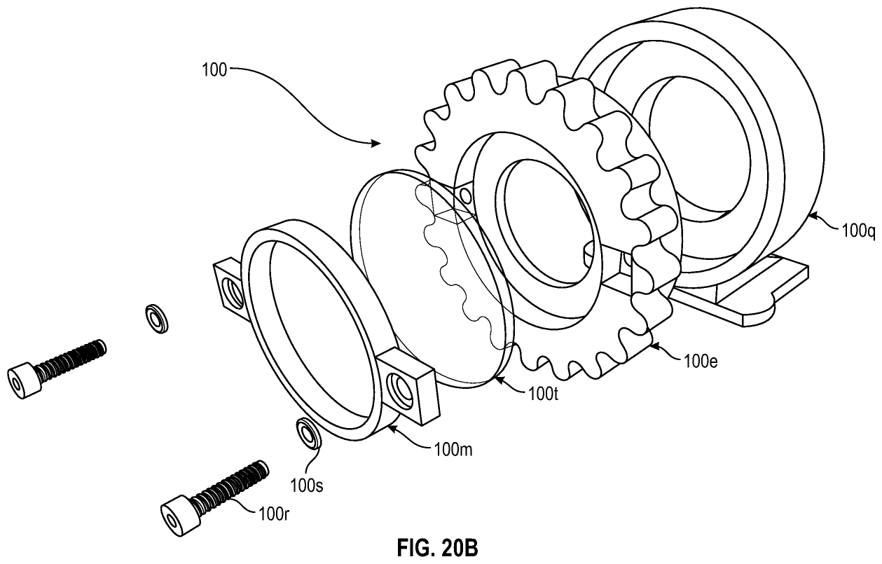

FIGS. 20A-20B are exploded, perspective views of the rotation plate assembly 100 according to an embodiment of the present disclosure. The plate assembly 100 can have a 25 mm diameter (for example) optic mounted in plate. M2 socket head screws (for example) are used to secure plate key to rotation plate front. Rotation plate front is allowed to freely rotation about horizontal axis.

In an exemplary embodiment, the plate assembly housing 100q can receive the plate assembly knob 100e. In particular, the plate assembly base receiving area 100u can receive the plate assembly knob rim 100f. A plate assembly optic 100t may fit against the plate assembly ledge 100k and within the central space defined by the circumferential teeth 100g. The plate assembly key 100m can sandwich the optic 100t between the key 100m and the ledge 100k. A plate assembly bolt 100r and plate assembly washer 100s may then pass through the plate assembly ring hole 1000 and the plate assembly knob hole 100i.

### Examples

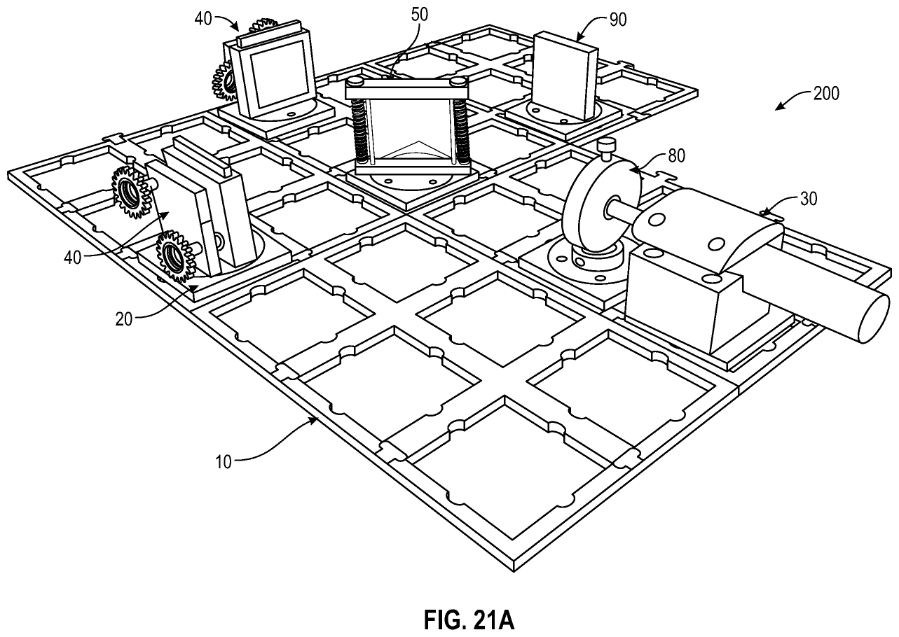

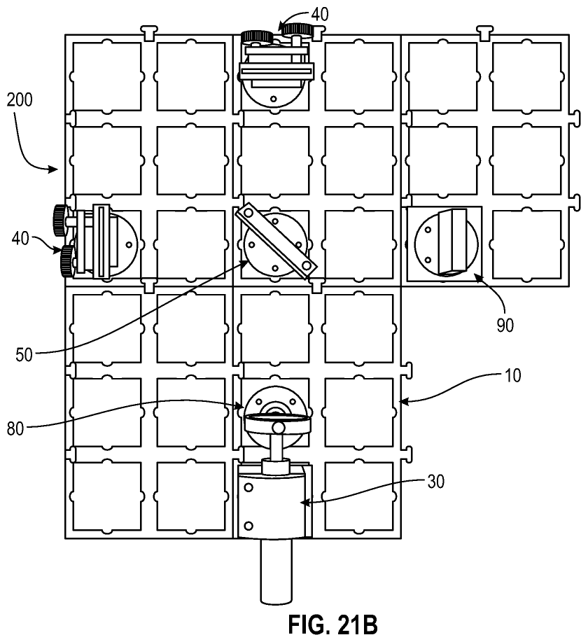

FIGS. 21A-21B depict a first exemplary configuration or system of one or more of the foregoing components. This exemplary system can be used to demonstrate a Michelson Interferometer experiment.

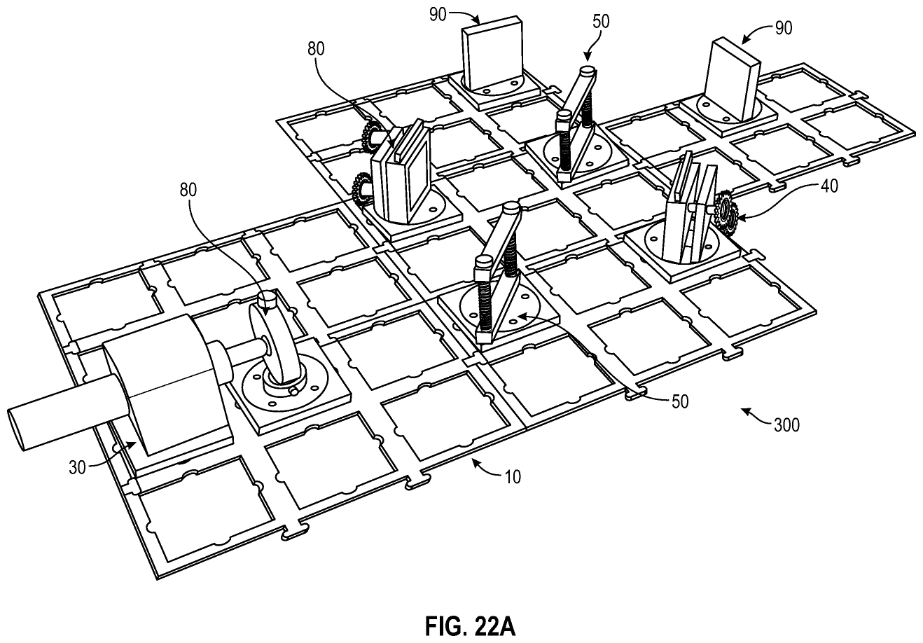

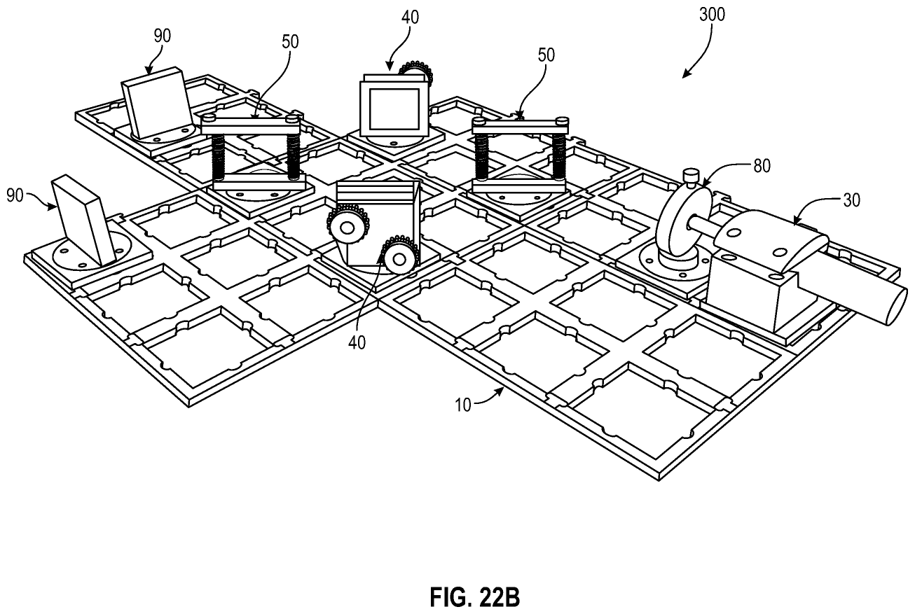

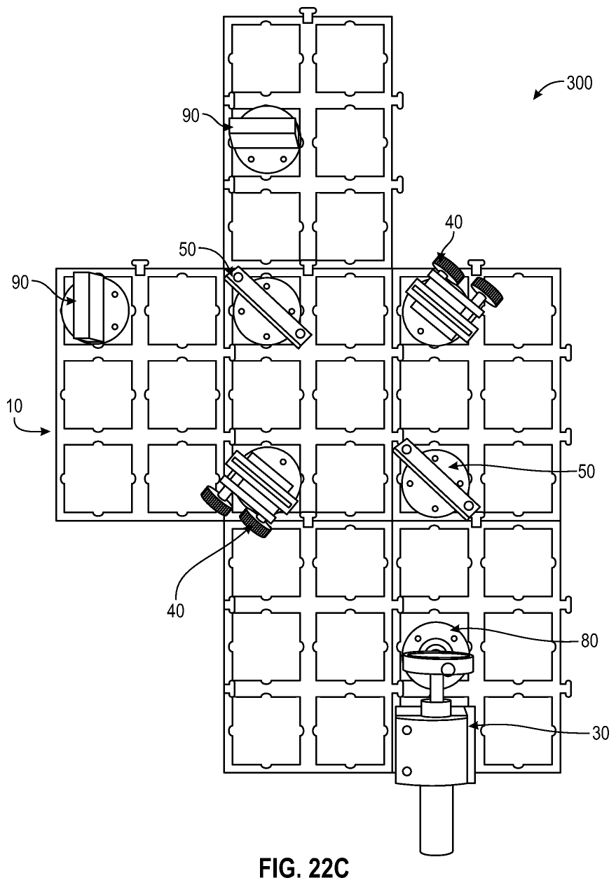

FIGS. 22A-22C depict a second exemplary configuration or system of one or more of the foregoing components. This exemplary system can be used to demonstrate a Mach Zehnder Interferometer experiment.

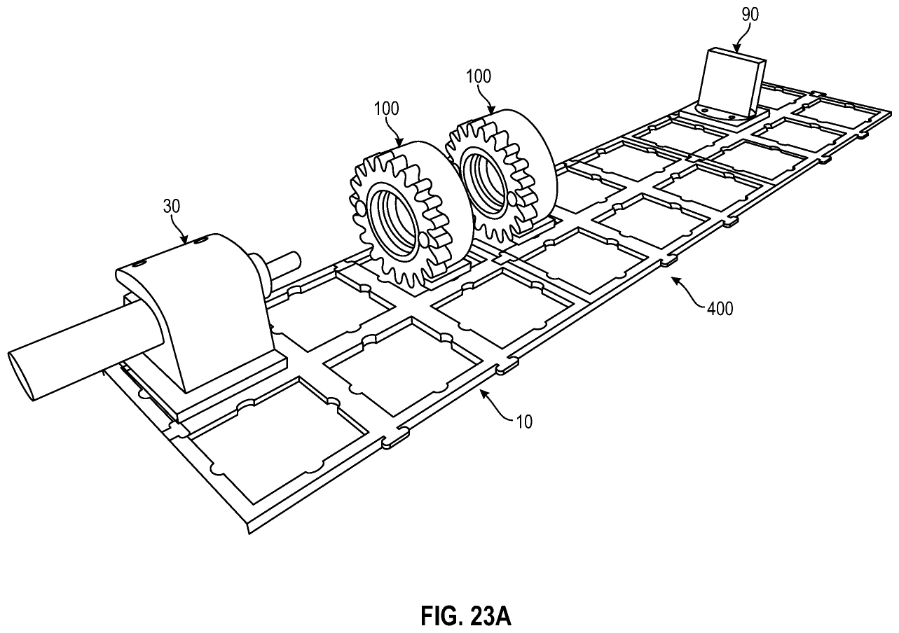

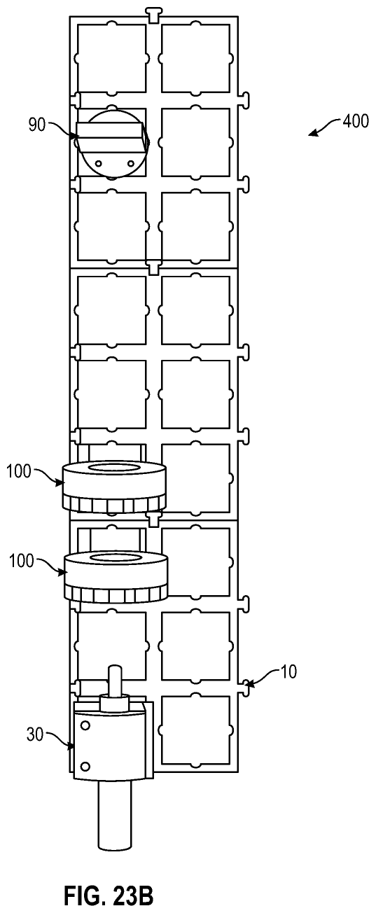

FIGS. 23A-23B depict a third exemplary configuration or system of one or more of the foregoing components. This exemplary system can be used to demonstrate a Malus's law experiment.

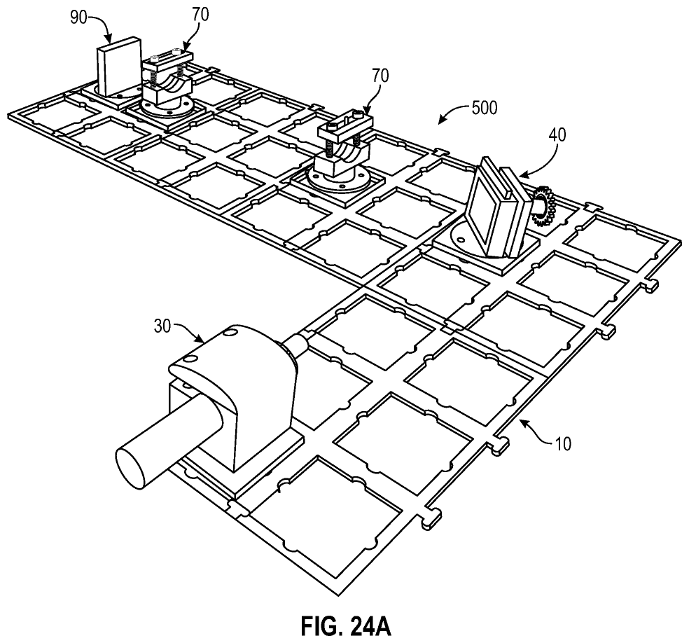

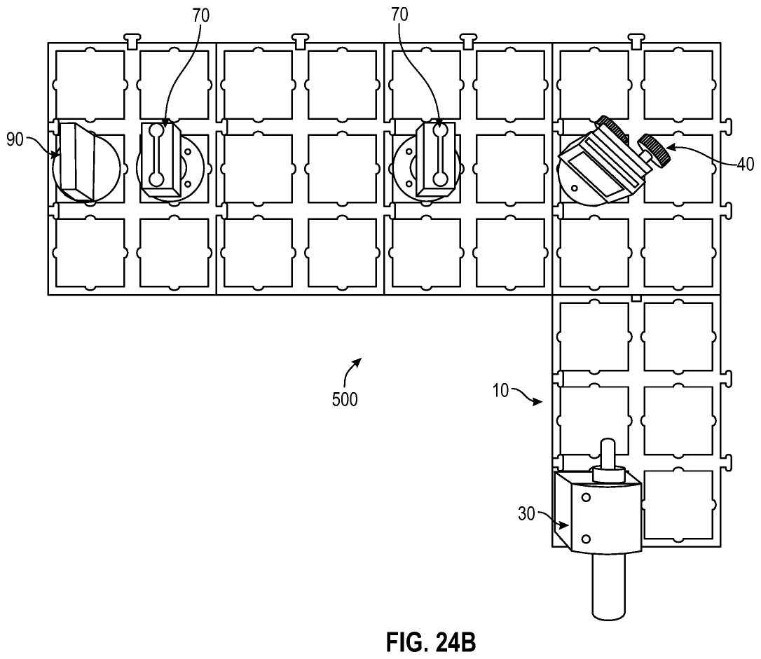

FIGS. 24A-24B depict a fourth exemplary configuration or system of one or more of the foregoing components. This exemplary system can be used to demonstrate an experiment for understanding optical alignment.

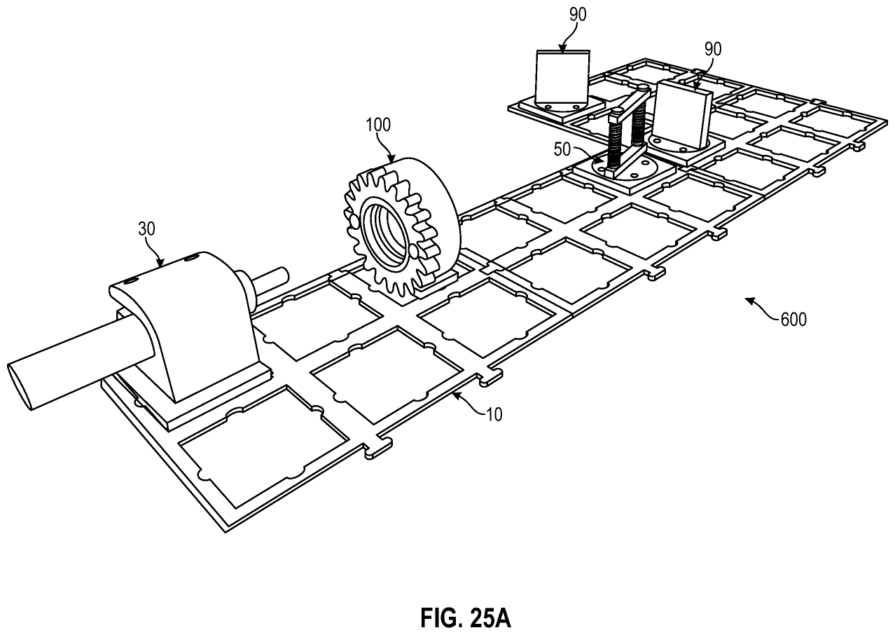

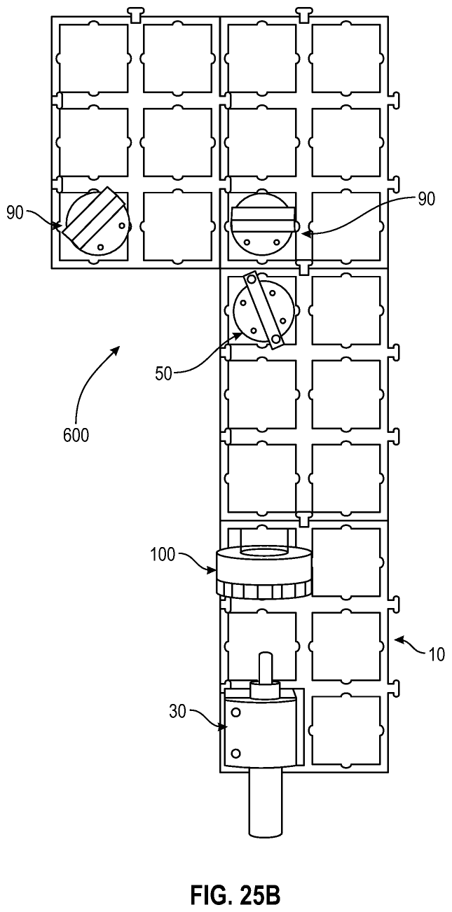

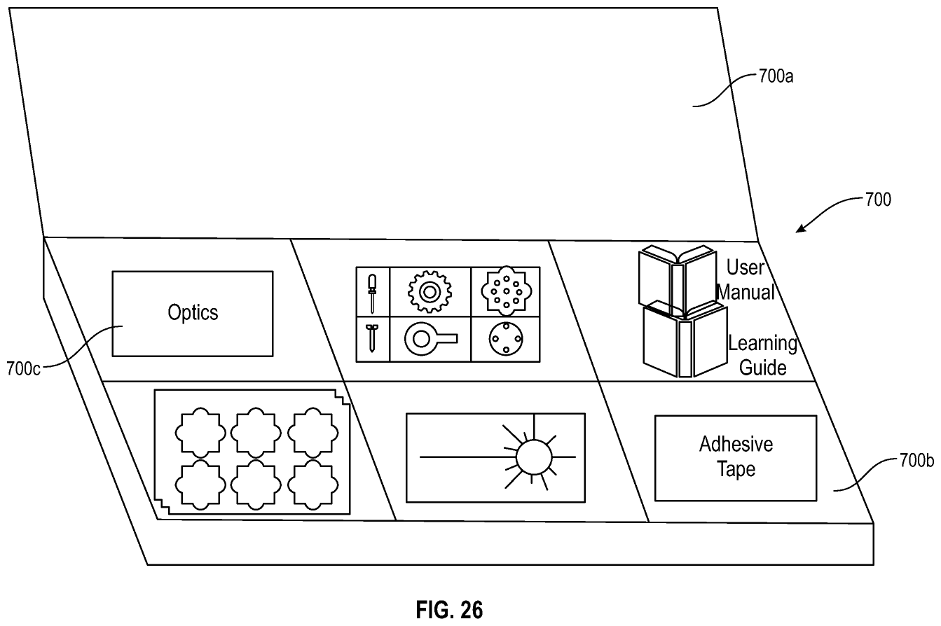

FIGS. 25A-25B depict a fifth exemplary configuration or system of one or more of the foregoing components. This exemplary system can be used to demonstrate a Brewster's angle experiment.

It should be understood, of course, that the foregoing relates to exemplary embodiments of the disclosure and that modifications may be made without departing from the spirit and scope of the disclosure as set forth in the following claims.

We claim:

1. A laser optics experiment kit, comprising:
a baseplate;
an adapter plate configured to directly attach to the baseplate;
a plurality of adapter components configured to releasably attach at varying angular positions to the adapter plate, including:
a mirror mount assembly;
a beamsplitter assembly;
an iris mount assembly;
a lens mount assembly; and
a viewing panel.

2. The kit of claim 1, further comprising:
a plurality of baseplate components, including:
a laser holder; and
a rotation plate assembly.

3. The kit of claim 2, wherein:
each of the plurality of baseplate components is configured to be positioned at varying angular positions at a plurality of baseplate locations on the baseplate.

4. The kit of claim 1, wherein:
the adapter plate is configured to be positioned at varying angular positions at a plurality of baseplate locations on the baseplate.

5. The kit of claim 1, wherein:
the baseplate is configured to receive the adapter plate at a plurality of baseplate locations on the baseplate.

6. The kit of claim 1, wherein:
the adapter plate is configured to releasably attach in varying angular positions to each of the plurality of adapter components.

7. The kit of claim 1, wherein:
the baseplate includes a plurality of baseplate modules that are configured to releasably connect with one another.

8. A laser optics experiment kit, comprising:
a baseplate;
an adapter plate configured to attach to the baseplate;
a plurality of baseplate components configured to directly attach to the baseplate, including:
a laser holder; and
a rotation plate assembly.

9. The kit of claim 8, further comprising:
a plurality of adapter components configured to releasably attach in varying angular positions to the adapter plate, including:
a mirror mount assembly;
a beamsplitter assembly;
an iris mount assembly;
a lens mount assembly; and
a viewing panel.

10. The kit of claim 8, wherein:
the baseplate includes a plurality of baseplate insertion areas.

11. The kit of claim 10, wherein the adapter plate is configured to be releasably inserted into the insertion areas.

12. The kit of claim 8, wherein:
the baseplate includes a plurality of baseplate modules that each have releasable connectors at perimeter edges thereof.

13. The kit of claim 8, wherein:
each of the baseplate components is configured to be releasably connected to the baseplate.

14. The kit of claim 9, wherein each of the adapter components is configured to be releasably attached at varying angular positions to the adapter plate.

15. A laser optics experiment kit, comprising:
a modular baseplate;
an adapter plate configured to releasably attach to the baseplate;
at least one of a plurality of components configured to releasably attach in varying angular positions to the adapter plate, including:
a lens holder;
a mirror mount assembly;
a beamsplitter assembly;
an iris mount assembly;
a lens mount assembly;
a viewing panel; and
a rotation plate assembly.

16. The kit of claim 15, wherein:
the modular baseplate includes a plurality of perimeter edges and a plurality of cross bars.

17. The kit of claim 16, wherein:
the adapter plate is configured to releasably attach to the plurality of perimeter edges and cross bars.

18. The kit of claim 15, further comprising:
a laser insertable into the laser holder.

19. The kit of claim 15, further comprising:
a post holder configured to connect at least one of the plurality of components to the adapter plate.

20. The kit of claim 15, further comprising:
a compartmentalized tray configured to hold at least one of the plurality of components.
